(19) United States
(12) Patent Application Publication
(10) Pub. No.: US 2026/0066357 A1
(43) Pub. Date: Mar. 5, 2026

(54) ENERGY STORAGE ELEMENT, AND METHOD FOR MANUFACTURING SUCH AN ENERGY STORAGE ELEMENT

(71) Applicant: VARTA Microbattery GmbH, Ellwangen Jagst (DE)

(72) Inventors: Edward PYTLIK, Ellwangen (DE); Michael GEIGER, Ellwangen (DE); Waldemar FRANK, Ellwangen (DE); David ENSLING, Ellwangen (DE)

(21) Appl. No.: 19/107,076

(22) PCT Filed: Sep. 6, 2023
(86) PCT No.: PCT/EP2023/074511

§ 371 Date: Feb. 27, 2025

(30) Foreign Application Priority Data
Sep. 7, 2022 (EP) 22194400.2

(51) Int. Cl. H01M 10/0587; H01M 4/75; H01M 10/04; H01M 50/107; H01M 50/119; H01M 50/152; H01M 50/184; H01M 50/474

(52) U.S. Cl. CPC H01M 10/0587; H01M 4/75; H01M 10/049; H01M 50/107; H01M 50/119; H01M 50/152; H01M 50/184; H01M 50/474

(57) ABSTRACT

An energy storage element includes an electrode-separator assembly in the form of a cylindrical winding having an anode, a separator, and a cathode. The anode includes a ribbon-shaped anode current collector with longitudinal edges and a free edge strip. The cathode includes a ribbon-shaped cathode current collector with longitudinal edges and a free edge strip. The energy storage element further includes a housing closed in an airtight and liquid-tight manner. A first longitudinal edge corresponding to a first free edge strip forms an area on which a metal part covering a first end face of the cylindrical winding lies flat, and a bottom of the housing includes an aperture into which a projection of the metal part is inserted or through which the projection protrudes.

### CROSS REFERENCE TO RELATED APPLICATIONS

This application is a U.S. National Phase application under 35 U.S. C. § 371 of International Application No. PCT/EP2023/074511, filed on Sep. 6, 2023, and claims benefit to European Patent Application No. EP 22194400.2, filed on Sep. 7, 2022. The International Application was published in German on Mar. 14, 2024 as WO 2024/052435 under PCT Article 21(2).

### FIELD

The present disclosure relates to an energy storage element and a method of manufacturing such an energy storage element.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs in the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions.

The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials that can be used for the positive electrode include lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF4) in organic solvents (e.g. ethers and esters of carbonic acid).

The composite electrodes are generally combined with one or more separators to form an electrode-separator assembly when manufacturing a lithium-ion cell. The electrodes and separators are often, but not necessarily, joined together under pressure, possibly by lamination or bonding. The basic functionality of the cell can then be established by impregnating the assembly with the electrolyte.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode (cathode)/separator/negative electrode (anode). In the second case, a ribbon-shaped positive electrode and a ribbon-shaped negative electrode and at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in tools, lithium-ion cells with the highest possible energy density are required that are also capable of withstanding high currents during charging and discharging.

Cells for the applications mentioned are often shaped as cylindrical round cells, for example with a form factor of 21×70 (diameter*height in mm). Cells of this type always comprise an assembly in the form of a winding. Modern lithium-ion cells of this form factor can already achieve an energy density of up to 270 Wh/kg.

According to WO 2017/215900 A1, cylindrical round cells are formed in which the electrode-separator assembly and its electrodes are ribbon-shaped and are in the form of a winding. The electrodes each have current collectors loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has a contact plate which rests on one end face of the winding and is connected to a longitudinal edge of one of the current collectors by welding. This makes it possible to electrically contact the current collector and thus also the associated electrode over its entire length. This significantly reduces the internal resistance within the described cell. As a result, the occurrence of large currents can be absorbed much better and heat can also be dissipated better from the winding.

However, in the case of cells such as those described in WO 2017/215900 A1, it is always necessary to connect the contact plate to a housing part or a pole passing through a housing part via a separate electrical conductor. The separate electrical conductor requires space within the housing. Furthermore, its use requires additional assembly work.

### SUMMARY

In an embodiment, the present disclosure provides an energy storage element. The energy storage element includes an electrode-separator assembly in the form of a cylindrical winding with a first terminal end face, a second terminal end face, and a winding shell therebetween. The electrode-separator assembly includes an anode, a separator, and a cathode in a sequence anode/separator/cathode. The anode includes a ribbon-shaped anode current collector with a first longitudinal edge, a second longitudinal edge parallel thereto, a main region loaded with a layer of a negative electrode material, and a free edge strip extending along the first longitudinal edge and being not loaded with the negative electrode material. The cathode includes a ribbon-shaped cathode current collector with a first longitudinal edge, a second longitudinal edge parallel thereto, a main region loaded with a layer of a positive electrode material, and a free edge strip extending along the first longitudinal edge and being not loaded with the positive electrode material. The anode and the cathode are formed and/or arranged within the electrode-separator assembly, which is formed as a winding, such that the free edge strip of the cathode current collector or the free edge strip of the anode current collector protrudes from the first terminal end face. The energy storage element further includes a housing closed in an airtight and liquid-tight manner. The housing includes a metallic housing cup and a lid. The metallic housing cup includes a bottom, a circumferential side wall, and a terminal opening. The energy storage element further includes a one-piece metal part covering the first terminal end face and comprising a flat region and a projection pointing away from the first terminal end face. The energy storage element additionally includes an electrically insulating seal that insulates the bottom of the metallic housing cup and the one-piece metal part. The anode and the cathode are formed and/or arranged within the electrode-separator assembly such that a respective free edge strip protrudes from the first terminal end face. The respective free edge strip is the free edge strip of the anode current collector or the free edge strip of the cathode current collector. The respective free edge strip is welded to the flat region of the metal part. A respective first longitudinal edge corresponding to the respective free edge strip forms an area on which the metal part covering the first end face lies flat at least in a subareas or into which the metal part is pressed at least in a subarea. The bottom of the housing cup comprises an aperture into which the projection is inserted or through which the projection protrudes, such that the projection is configured to be mechanically contacted from outside the housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a first embodiment of an energy storage element in a longitudinal sectional view;

FIG. 2 illustrates second embodiment of an energy storage element in a longitudinal sectional view;

FIG. 3 illustrates a third embodiment of an energy storage element in a longitudinal sectional view;

FIG. 4 illustrates a longitudinal sectional view of an electrode-separator assembly to which a first metal part and a second metal part are connected by welding;

FIG. 5 illustrates an electrode-separator assembly, which is part of an energy storage element, and its components;

FIG. 6 provides sequence of process steps of a method of manufacturing an energy storage element; and

FIG. 7 illustrates a fourth embodiment of an energy storage element in a longitudinal sectional view.

### DETAILED DESCRIPTION

The present disclosure provides an energy storage element and a method of manufacturing and energy storage element.

### Storage Element

An energy storage element is provided that has the following features a. to f.:

a. The energy storage element comprises an electrode-separator assembly with the sequence anode/separator/cathode, wherein

the anode of the electrode-separator assembly is ribbon-shaped and comprises a ribbon-shaped anode current collector which has a first longitudinal edge and a second longitudinal edge parallel thereto,

the ribbon-shaped anode current collector comprises a main region which is loaded with a layer of a negative electrode material and a free edge strip which extends along its first longitudinal edge and which is not loaded with the negative electrode material,

the cathode of the electrode-separator assembly is ribbon-shaped and comprises a ribbon-shaped cathode current collector which has a first longitudinal edge and a second longitudinal edge parallel thereto,

the ribbon-shaped cathode current collector comprises a main region which is loaded with a layer of a positive electrode material and a free edge strip which extends along its first longitudinal edge and which is not loaded with the positive electrode material,

the electrode-separator assembly is in the form of a cylindrical winding with a first terminal end face and a second terminal end face and a winding shell between them and comprises the anode and the cathode in spirally wound form,

the anode and the cathode are formed and/or arranged within the electrode-separator assembly, which is formed as a winding, such that the free edge strip of the cathode current collector or the free edge strip of the anode current collector protrudes from the first terminal end face,

b. the energy storage element comprises a housing which is sealed in an airtight and liquid-tight manner and has a metallic housing cup with a bottom and a circumferential side wall as well as a terminal opening and a lid,

c. the energy storage element comprises a metal part covering the first terminal end face,

d. the metal part comprises a flat region to which the free edge strip protruding from the first terminal end face is welded, and a projection pointing away from the first terminal end face,

e. the bottom of the housing cup has an aperture into which the projection is inserted or through which the projection protrudes, so that the projection can be mechanically contacted from outside the housing, and

f. the bottom and the metal part are insulated from each other by an electrically insulating seal.

The free edge strip protruding from the terminal end face can be the free edge strip of the cathode current collector or the free edge strip of the anode current collector. Preferably, it is the free edge strip of the cathode current collector.

In contrast to WO 2017/215900 A1, the energy storage element has a metal part which simultaneously functions as a closure means for the housing of the energy storage element, as a conductor for the current from the anode or cathode current collector and as a pole. Accordingly, there is no need for a separate electrical conductor, as is known from the prior art, positioned generally between a lid or lid assembly and a contact plate, as described in WO 2017/215900 A1. The energy storage element is therefore particularly easy to manufacture. The absence of the separate conductor and the separate pole also means that the internal resistance of the energy storage element can be reduced and that more usable volume is available in the housing, which means that more active material can be introduced into the housing to increase the energy density.

### Preferred Design of the Metal Part

Preferably, the energy storage element is characterized by at least one of the features a. and b. immediately below:

a. The projection of the metal part pointing away from the first terminal end face is shaped as a cup.

b. The metal part including the projection is a one-part piece.

It is preferred that the immediately preceding features a. and b. are realized in combination.

The metal part with the cup-shaped projection can be manufactured in a deep-drawing process, for example, and is then preferably formed as a one-part piece. However, it can also be manufactured from a metallic workpiece by a forming or machining production step or by means of 3D printing, for example.

Preferably, the metal part including the projection is a sheet metal formed in a deep-drawing process.

The complexity of the structure of the energy storage element is further reduced by each of these features taken individually and in particular by these features in one of the combinations mentioned compared to energy storage elements known from the prior art, which leads to an even more favorable overall manufacturing process and to an even greater reduction in the internal resistance of the energy storage element.

### Connection of one of the Electrodes to the Housing Cup and Preferred Second Metal Part

While one of the electrodes of the energy storage element is electrically connected to the metal part as the first metal part via the free edge strip protruding from the first terminal end face, the other of the electrodes is preferably electrically connected to a second metal part.

Accordingly, the energy storage element is preferably characterized by at least one of the features a. to e. immediately below:

a. The ribbon-shaped electrodes are formed as and/or arranged within the electrode-separator assembly, which is formed as a winding, in such a way that one of the free edge strips of the anode current collector or of the cathode current collector protrudes from the first terminal end face and the other of the free edge strips protrudes from the second terminal end face of the electrode-separator assembly.

b. The energy storage element comprises the metal part covering the first terminal end face as the first metal part.

c. A second metal part covers the second terminal end face and is welded directly to the free edge strip protruding from the second terminal end face.

d. The second metal part forms the lid of the housing.

e. The second metal part closes the terminal opening of the housing cup.

It is preferred that the immediately preceding features b. and c., b. to d., b. to e. or a. to e. are realized in combination.

The free edge strip protruding from the first terminal end face is preferably the free edge strip of the cathode current collector. Accordingly, the edge strip protruding from the second terminal end face is preferably the free edge strip of the anode current collector.

In principle, it is also possible that a separate electrical conductor is welded to the second metal part, which in turn is electrically coupled to one of the electrodes. In these cases, there is therefore no direct connection between an edge strip of one of the current collectors and the second metal part.

### Preferred Shaping of the Metal Parts, the Terminal Opening and the Seal

Preferably, the energy storage element is characterized by at least one of the features a. to e. immediately below:

a. The terminal opening of the housing cup has a circular shape.

b. The first and/or the second metal part is a disk and has a circular edge.

c. The circular edge of the second metal part is bent by 90°.

d. The seal is formed as a disk or annular at least in some areas and has a circular edge.

e. The energy storage element comprises an insulating means made of an electrically insulating material, which is arranged between the edge of the metal part covering the first end face and the housing cup and electrically insulates the edge of the first metal part from the potential of the housing cup.

It is preferred that the immediately preceding features are realized in any combination, but in particular in the combinations a. and b., a., b. and d., b. and c. or a. to e.

The electrically insulating material can be a material containing polyimide, for example, which can be vapor-deposited, sprayed or glued on. In particular, an adhesive tape containing polyimide (e.g. Kapton® adhesive tape from DuPont) is particularly suitable as an electrically insulating material for electrically insulating the edge of the (first) metal part from the potential of the housing cup.

In addition to the function of electrically insulating the first metal part and the bottom of the housing cup from each other, the seal also has the function of sealing the housing from the outside, i.e. preventing the electrolyte from leaking or foreign substances from entering the energy storage element.

### Preferred Housing Design

Preferably, the energy storage element is characterized by at least one of the features a. to c. immediately below:

a. The housing comprises the bottom, a central section and a lid closure section in axial sequence.

b. In the central section, the winding shell of the electrode-separator assembly, which is formed as a winding, is in contact with the inside of the housing cup.

c. The central section has a cylindrical shape.

It is preferred that the immediately preceding features a. to c. are realized in combination.

The energy storage element is preferably a cylindrical round cell. Cylindrical round cells are known to have a cylindrical housing with a generally circular bottom.

Preferably, the height of the energy storage element, which is formed as a cylindrical round cell, is in a range from 50 mm to 150 mm. Its diameter is preferably in a range from 15 mm to 60 mm. Cylindrical round cells with these form factors are particularly suitable for supplying power to electric drives in motor vehicles.

Preferably, the winding shell of the electrode-separator assembly formed as a winding lies directly against the inside of the housing cup in the central section. In some examples, the inside of the housing in the central section is electrically insulated, for example by means of a film. In this case, the winding shell of the electrode-separator assembly is preferably in contact with or rests against the inside of the housing cup lined with the foil.

The lid closure section comprises the region of the cell that is closed by the lid.

Preferably, the lid closure section and the bottom of the housing cup are located at opposite ends of the energy storage element.

### Embodiment With Spacer

Preferably, the energy storage element is characterized by at least one of the features a. to c. immediately below:

a. The metal part covering the first end face has a first side facing the bottom of the housing cup and a second side facing the electrode-separator assembly.

b. An annular spacer made of an electrically insulating material is arranged between the bottom of the housing cup and the metal part covering the first end face.

c. The spacer, the first side of the metal part covering the first end face and the bottom of the housing cup form an annular gap which is filled by the seal.

It is preferred that the immediately preceding features a. to c. are realized in combination.

In further embodiments described above and specifically below, the metal part covering the first end face may be the first metal part.

A thermoplastic material such as polybutylene terephthalate (PBT), polypropylene (PP), polyethylene (PE) or polyphenylene sulphide (PPS) is suitable as a material for the spacer. The spacer has the function of maintaining a distance between the metal part covering the first end face and the bottom of the housing cup so that the first side of the metal part covering the first end face, the spacer itself and the bottom of the housing cup form an annular gap which can be filled by the seal.

The seal preferably consists of a hardened potting material which was poured into the annular gap during the manufacture of the energy storage element. A solvent-resistant plastic material is suitable for the seal, preferably a thermosetting plastic material such as an epoxy resin, an elastomeric plastic material or a thermoplastic plastic material such as a polyester. For example, the seal can be made of an epoxy resin (e.g. Loctite® EA 9497 from Henkel).

### Further Preferred Embodiments of the First and Second Metal Part

Preferably, the energy storage element is characterized by at least one of the features a. to f. immediately below:

a. The first longitudinal edge, along which the free edge strip protruding from the first terminal end face of the electrode-separator assembly extends, forms an area on which the metal part covering the first end face lies flat, at least in a subarea, or into which the metal part is pressed, at least in a subarea.

b. The first longitudinal edge, along which the free edge strip protruding from the second terminal end face of the electrode-separator assembly extends, forms an area on which the metal part covering the second end face lies flat, at least in a subarea, or into which the metal part is pressed, at least in a subarea.

c. The metal part covering the first end face is dimensioned such that it covers at least 40 %, preferably at least 60 %, preferably at least 80 %, of the first terminal end face.

d. The metal part covering the second end face is dimensioned such that it covers at least 40 %, preferably at least 60 %, preferably at least 80 %, of the first terminal end face.

e. The metal part covering the first end face and/or the metal part covering the second end face has a preferably uniform thickness in a range from 50 μm to 600 μm, preferably in a range from 150 μm to 350 μm.

f. The projection of the metal part covering the first end face is has a cylindrical shape and appears as a cylindrical depression on the second side of the metal part and as a cylindrical elevation on the first side of the metal part.

It is preferred that the immediately preceding features a. and c. and/or b. and c. are realized in combination. In further embodiments, the features a. and c. and e. and/or b. and c. and e. are realized in combination. Preferably, the features a. and c. and e. and f. and/or b. and c. and e. and f. are realized in combination

As already mentioned above, the projection of the metal part covering the first end face acts as a pole that can be electrically coupled to an external energy consumer either indirectly via a conductor or directly by mechanical means.

### Preferred Embodiments of the Lid Closure Section

In preferred embodiments, the lid is welded into the terminal opening of the housing cup to seal it. The lid and the housing cup then have the same polarity.

In another variant, however, the lid can also be electrically insulated from the housing cup. In this embodiment, the lid can serve as the pole of the energy storage element, while the housing cup can be potential-free.

Preferably, the energy storage element in this further variant is characterized by at least one of the features a. to d. immediately below:

a. The central section and the lid closure section are separated from each other by a radial bead that circumfers the outside of the housing cup in an annular shape.

b. The energy storage element comprises the seal electrically insulating the bottom of the housing cup and the first metal part from each other as a first seal.

c. A second seal is arranged in the lid closure section, which is in press contact with the second metal part forming the lid of the housing and the inside of the housing cup.

d. The second seal has an annular shape and has a circular edge.

It is preferred that the immediately preceding features a. to d. are realized in combination.

To make press contact, the housing cup is usually pressed radially inwards against the lid, compressing the second seal. This can also be done as part of a crimping process, in which the annular circumferential radial bead can play a role.

In embodiments of the energy storage element according to the above variant with the second seal, which is in press contact with the second metal part forming the lid of the housing and the inside of the housing cup, it may be preferred that the energy storage element comprises a reference electrode inside the housing, which is electrically connected to the housing cup. The reference electrode may, for example, be metallic lithium or a lithium compound. Preferably, the reference electrode is in direct contact with the housing cup, in particular the inside of the housing cup. For example, the inside of the casing of the housing cup can be lined with a thin layer of lithium.

In further preferred embodiments, the energy storage element is characterized by at least one of the features a. to f. immediately below:

a. The energy storage element has a protection against internal overpressure in the lid closure section.

b. The second metal part forming the lid of the housing has an opening and a recessed area surrounding the opening, in which the thickness is reduced compared to the rest of the second metal part.

c. The opening of the second metal part has a circular shape.

d. The opening of the second metal part is closed by a membrane which is designed to burst in the event of a predetermined overpressure inside the housing.

e. The membrane is embedded in the recessed area of the second metal part.

f. A surface of the membrane facing away from the electrode-separator assembly extends in a common plane with a surface of the second metal part facing away from the electrode-separator assembly.

It is preferred that the immediately preceding features a. to f. are realized in combination.

### Preferred Material Properties of Current Collectors, Housing Cups and Metal Parts

The current collectors of the energy storage element have the function of electrically contacting electrochemically active components contained in the respective electrode material over as large an area as possible. Preferably, the current collectors are made of a metal or are at least metallized on the surface.

The material properties of the current collectors depend, among other things, on the electrochemical conditions, in particular the electrode chemistry.

In the case of an energy storage element formed as a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are particularly suitable as nickel alloys. Stainless steel can also be considered, for example type 1.4303 or 1.4404 or type SUS304.

In the case of an energy storage element formed as a lithium-ion cell, aluminum or other electrically conductive materials, including aluminum alloys, are particularly suitable as a metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a ribbon-shaped metal foil with a thickness in a range from 4 μm to 30 μm.

In addition to films, however, other ribbon-shaped substrates such as metallic or metallized nonwovens or open-pored metallic foams or expanded metals can also be used as current collectors.

The current collectors are preferably loaded with the respective electrode material on both sides.

The housing cup preferably consists of aluminum, an aluminum alloy or a steel sheet, for example a nickel-plated steel sheet. Suitable aluminum alloys for the housing cup are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

The nature of the metal part adjacent to the first end face and any second metal part present depends on whether the free edge strip protruding from the first terminal end face is the free edge strip of the cathode current collector or the free edge strip of the anode current collector.

If the free edge strip protruding from the first terminal end face is the free edge strip of the cathode current collector, it is preferred that the metal part abutting the first end face is made of the same or a chemically similar material as the cathode current collector, i.e. in particular of aluminum or an aluminum alloy.

If the free edge strip protruding from the first terminal end face is the free edge strip of the anode current collector, it is preferred that the metal part abutting the first end face is made of the same or chemically similar material as the anode current collector, i.e. in particular of copper or nickel, nickel-plated copper, a copper or nickel alloy or stainless steel.

In some preferred embodiments, the seal consists of an electrically insulating plastic material that has a melting point of >200° C., preferably >300° C. The plastic material is a polyether ether ketone (PEEK), a polyimide (PI), a polyphenyl sulphide (PPS) or a polytetrafluoroethylene (PTFE).

### Electrodes and Electrode Materials

In a preferred embodiment, the energy storage element is a lithium-ion cell.

Basically, all electrode materials known for secondary lithium-ion cells can be used for the electrodes of the energy storage element.

Carbon-based particles such as graphitic carbon or non-graphitic carbon materials capable of intercalation with lithium, preferably also in particle form, can be used as active materials in the anodes. Alternatively or additionally, lithium titanate (Li₄Ti₅O₁₂) or a derivative thereof can also be contained in the anode, preferably also in particle form. Furthermore, the anode can contain as active material at least one material from the group comprising silicon, aluminum, tin, antimony or a compound or alloy of these materials that can reversibly intercalate and redeposit lithium, for example silicon oxide (in particular LiOₓ with 0<x<2), optionally in combination with carbon-based active materials. Tin, aluminum, antimony and silicon can form intermetallic phases with lithium. The capacity for the receptable of lithium exceeds that of graphite or comparable materials many times over, especially in the case of silicon. Mixtures of silicon and carbon-based storage materials are often used. Thin anodes made of metallic lithium are also suitable.

Suitable active materials for the cathodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y+z is typically 1) is also particularly suitable, lithium manganese spinel (LMO) with the chemical formula LiMn₂O₄, or lithium cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM—O compounds and/or mixtures of the aforementioned materials can also be used. The cathodic active materials are also preferably used in particulate form.

In addition, the electrodes of an energy storage element preferably contain an electrode binder and/or an additive to improve the electrical conductivity. The active materials are preferably embedded in a matrix of the electrode binder, with adjacent particles in the matrix preferably being in direct contact with each other. Conductive agents have the function of elevating the electrical conductivity of the electrodes. Common electrode binders are based, for example, on polyvinylidene fluoride (PVDF), (Li-)polyacrylate, styrene-butadiene rubber or carboxymethyl cellulose or mixtures of different binders. Common conductive agents are carbon black, fine graphite, carbon fibers, carbon nanotubes and metal powder.

### Sodium Ion-Based Embodiment

In further embodiments, the energy storage element may also be a sodium-ion cell, a potassium-ion cell, a calcium-ion cell, a magnesium-ion cell or an aluminum-ion cell. Among these variants, energy storage elements with sodium-ion cell chemistry are preferred.

Preferably, the sodium ion-based energy storage element comprises an electrolyte comprising at least one of the following solvents and at least one of the following conducting salts:

Organic carbonates, ethers, nitriles and mixtures thereof are particularly suitable as solvents. Preferred examples are

Carbonates: Propylene carbonate (PC), ethylene carbonate-propylene carbonate (EC-PC), propylene carbonate-dimethyl carbonate-ethyl methyl carbonate (PC-DMC-EMC), ethylene carbonate-diethyl carbonate (EC-DEC), ethylene carbonate-dimethyl carbonate (EC-DMC), ethylene carbonate-ethyl methyl carbonate (EC-EMC), ethylene carbonate-dimethyl carbonate-ethyl methyl carbonate (EC-DMC-EMC), ethylene carbonate-dimethyl carbonate-diethyl carbonate (EC-DMC-DEC)

Ethers: tetrahydrofuran (THE), 2-methyltetrahydrofuran, dimethyl ether (OME), 1,4-dioxane (DX), 1,3-dioxolane (DOL), diethylene glycol dimethyl ether (DEGDME), tetraethylene glycol dimethyl ether (TEGDME)

Nitriles: Acetonitrile (ACN), adiponitrile (AON), y-butyrolactone (GBL)

Trimethyl phosphate (TMP) and tris(2,2,2-trifluoroethyl) phosphate (TFP) can also be used.

Preferred conductive salts are:

NaPF₆, sodium difluoro(oxalato)borate (NaBOB), NaBF₄, sodium bis(fluorosulfonyl)imide (NaFSI), sodium 2-trifluoromethyl-4,5-dicyanoimidazole (NaTDI), sodium bis(trifluoromethanesulfonyl)imide (NaTFSI), NaAsF₆, NaBF₄, NaCIO₄, NaB(C₂O₄)₂, NaP(C₆H₄O2)₃; NaCF₃SO₃, Natriumtriflate (NaTf) und Et₄NBF₄.

In preferred embodiments, additives may be added to the electrolyte. Examples of preferred additives, in particular for stabilization, are the following:

Fluoroethylene carbonate (FEC), transdifluoroethylene carbonate (DFEC), ethylene sulfite(ES), vinylene carbonate (VC), bis(2,2,2-trifluoroethyl)ether (BTFE), sodium 2-trifluoromethyl-4,5-dicyanoimidazole (NaTDI), sodium bis(fluorosulfonyl)imide (NaFSI), aluminum chloride (AICI₃) , ethylene sulfate (DTD), sodium difluorophosphate (NaPO₂F₂), sodium difluoro(oxalato)borate (NaODFB), sodium difluorobisoxalatophosphate (NaDFOP) and tris(trimethylsilyl)borate (TMSB).

The negative electrode material of an energy storage element based on sodium ions is preferably at least one of the following materials:

Carbon, especially hard carbon (pure or with nitrogen and/or phosphorus doping) or soft carbon or graphene-based materials (with N-doping); carbon nanotubes, graphite Phosphorus or sulphur (conversion anode)

Polyanions: Na₂Ti₃O₇, Na₃Ti₂(PO₄)₃, TiP₂O₇, TiNb₂O₇, Na—Ti—(PO₄)₃, Na—V—(PO₄)₃

Prussian blue: low-Na variant (for systems with aqueous electrolyte)

Transition metal oxides: V₂O₅, MnO₂, TiO₂, Nb₂O₅, Fe₂O₃, Na₂Ti₃O₇, NaCrTiO₄, Na₄Ti₅O₁₂

MXenes with M═Ti, V, Cr, Mo or Nb and A═AI, Si, and Ga as well as X═C and/or N, e.g. Ti₃C₂

Organic: e.g. Na terephthalates (Na₂C₈H₂O₄)

Alternatively, a sodium metal anode can also be used on the anode side.

The positive electrode material of an energy storage element based on sodium ions is, for example, at least one of the following materials:

Polyanions: NaFePO₄ (Triphylit-Typ), Na₂Fe—(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, Na₄(CoMnNi)₃(PO₄)₂P₂O₇, NaCoPO4, Na₂CoPO₄F

Silicates: Na₂MnSiO₄, Na₂FeSiO₄

Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂ In addition, the electrodes of an energy storage element preferably contain an electrode binder and/or an additive to improve the electrical conductivity. The active materials are preferably embedded in a matrix of the electrode binder, whereby the active materials are preferably used in particulate form and adjacent particles in the matrix are preferably in direct contact with each other. Conductive agents have the function of elevating the electrical conductivity of the electrodes. Common electrode binders are based on polyvinylidene fluoride (PVDF), (Na-)polyacrylate, styrene-butadiene rubber, (Na-)alginate or carboxymethyl cellulose, for example, or mixtures of different binders. Common conductive agents are carbon black, fine graphite, carbon fibers, carbon nanotubes and metal powder.

Preferably, in an energy storage element according to an embodiment, both the anode and the cathode current collector consist of aluminum or an aluminum alloy. The housing and the contact plates, as well as any other current conductors within the housing, may also consist of aluminum or the aluminum alloy.

### Preferred Material Embodiments of Electrolyte and Separator

The energy storage element preferably comprises a liquid electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

Like the electrodes, the separator of an electrode-separator assembly of the energy storage element is preferably formed as a ribbon-shaped separator. Where appropriate, the electrode-separator assembly of the energy storage element comprises more than one ribbon-shaped separator. For example, it may be preferred that the ribbon-shaped anode or the ribbon-shaped cathode is arranged between two ribbon-shaped separators.

The separator is preferably formed from an electrically insulating plastic film. It preferably has pores so that it can be penetrated by the liquid electrolyte. The plastic film can consist of a polyolefin or a polyether ketone, for example. Nonwovens and fabrics made of plastic materials or other electrically insulating fabrics can also be used as separators. Separators with a thickness in a range from 5 to 50 um are preferred.

However, it is also possible in principle for the ribbon-shaped separator to be a separator made from a solid electrolyte that has intrinsic ionic conductivity and does not need to be impregnated with a liquid electrolyte. The solid-state electrolyte can, for example, be a polymer solid-state electrolyte based on a polymer-conducting salt complex, which is present in a single phase without any liquid component. The polymer matrix of a solid-state polymer electrolyte can be polyacrylic acid (PAA), polyethylene glycol (PEG) or polymethyl methacrylate (PMMA). Lithium conductive salts such as lithium bis-(trifluoromethane)sulfonylimide (LiTFSI), lithium hexafluorophosphate (LIPF₆) and lithium tetrafluoroborate (LIBF₄) can be present in these.

### Preferred Shapes and Dimensions of Electrodes and Separator

The anode current collector, the cathode current collector and the separator or separators of the energy storage element preferably each have the following dimensions:

A length in a range from 0.5 m to 25 m,

A width in a range from 40 mm to 145 mm.

### Preferred Embodiments of the Electrode-Separator Assembly

It is preferred that the longitudinal edges of the separator or separators form the end faces of the electrode-separator assembly formed as a winding.

In order to prevent direct contact between oppositely polarized electrodes at the axial ends of the electrode-separator assembly in the form of the cylindrical winding, separators are preferably used that are slightly wider than the electrodes to be separated. In preferred embodiments, the electrode-separator assembly thus ends at its axial ends with a separator protrusion that forms the end faces from which the free edge strips of the current collectors protrude.

It is preferred that the free edge strips of the current collectors protruding from the terminal end faces of the winding do not protrude from the end faces by more than 5500 μm, preferably not more than 4000 μm.

Preferably, the free edge strip of the anode current collector protrudes from the end face of the winding by no more than 3000 μm, preferably by no more than 2000 μm. Preferably, the free edge strip of the cathode current collector protrudes from the end face of the winding by no more than 4000 μm, preferably by no more than 3000 μm.

In the electrode-separator assembly formed as a winding, the ribbon-shaped anode, the ribbon-shaped cathode and the ribbon-shaped separator(s) are spirally wound. To produce the assembly, the ribbon-shaped electrodes are preferably fed together with the ribbon-shaped separator(s) to a winding device and preferably wound up in this device in a spiral around a winding axis. In some embodiments, the electrodes and the separator or separators are wound onto a cylindrical or hollow-cylindrical winding core for this purpose, which rests on a winding mandrel and remains in the winding after winding.

The winding shell can be formed by a plastic film or an adhesive tape, for example. It is also possible for the winding shell to be formed by one or more separator windings.

In preferred embodiments, the end faces of the electrode-separator assembly formed as a winding are heat-treated before or during its assembly, in particular in such a way that the separator protrusion at least partially melts or is deformed under the effect of the heat. Appropriate pre-treatment also makes it possible to subject the separator protrusion to directional deformation. For example, the separator edges forming the end faces can be provided with a ceramic coating on one side only. If such a separator edge is heat-treated at suitable temperatures, it curls up and can close the end face in this way.

Preferably, the ribbon-shaped anode and the ribbon-shaped cathode are offset from each other within the electrode-separator assembly to ensure that the free edge strip of the anode current collector protrudes from one of the terminal end faces and the free edge strip of the cathode current collector protrudes from the other of the terminal end faces.

### PREFERRED NOMINAL CAPACITY OF THE ENERGY STORAGE ELEMENT

The nominal capacity of a lithium-ion-based energy storage element, which is formed as a cylindrical round cell, is preferably up to 15000 mAh. With the form factor of 21×70, the energy storage element in an embodiment as a lithium-ion cell preferably has a nominal capacity in a range from 1500 mAh to 7000 mAh, preferably in a range from 3000 mAh to 5500 mAh. With the form factor 18×65, the energy storage element in an embodiment as a lithium-ion cell preferably has a nominal capacity in a range from 1000 mAh to 5000 mAh, preferably in a range from 2000 mAh to 4000 mAh.

In the European Union, manufacturers'specifications regarding the nominal capacities of secondary batteries are strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

### Depot of Mobile Ions

The function of a lithium or sodium cell is based on the fact that sufficient mobile ions (mobile sodium ions in the case of a sodium-ion cell, mobile lithium ions in the case of a lithium-ion cell) are available to balance the electrical current drawn off by migration between the anode and the cathode or the negative electrode and the positive electrode. Mobile ions in the context of this application means that the ions are available for storage and retrieval processes in the electrodes as part of the discharging and charging processes of the energy storage element or can be activated for this purpose. In the course of the discharging and charging processes, e.g. of a lithium-ion cell, losses of mobile lithium occur over time. These losses occur as a result of various, generally unavoidable side reactions. Losses of mobile ions already occur during the first charging and discharging cycle. During this first charge and discharge cycle, a top layer generally forms on the surface of the electrochemically active components on the negative electrode. This top layer is known as the solid electrolyte interphase (SEI) and generally consists of electrolyte decomposition products and, in the case of lithium-ion cells, a certain amount of lithium that is firmly bound in this layer.

To compensate for these losses, sodium ion-based energy storage elements comprise, in preferred embodiments, a depot of sodium or a sodium-containing material not comprised by the positive and/or the negative electrode, which can be used to compensate for losses of mobile sodium during their operation.

Particularly suitable sodium-containing materials are, for example, Na₃P and Na₃N. These materials can be added to the electrode active material, for example.

In preferred embodiments, lithium-ion based energy storage elements comprise a depot of lithium or an lithium-containing material not comprised by the positive and/or the negative electrode, which can be used to compensate for losses of mobile lithium during their operation.

Metallic lithium, for example, is suitable.

In preferred embodiments, the metallic lithium of the reference electrode described above can serve as a lithium depot. By applying a corresponding voltage to the reference electrode, the concentration of lithium ions in the electrolyte can be actively controlled with particular advantage.

The same would also be conceivable with metallic sodium in the housing.

It is also conceivable that the electrodes are pre-charged with an excess of lithium or sodium ions.

### Manufacturing Process

The manufacturing process is used to manufacture the energy storage element described above and is characterized by the following features immediately below: a. to e:

a. A housing cup with a terminal opening and an aperture in the bottom and an electrode-separator assembly with a first and a second end face, each as already defined above for the energy storage element, are provided.

b. A metal part comprising a projection is provided.

c. The metal part is placed on the first end face and connected by welding to the free edge strip protruding from the first end face.

d. The electrode-separator assembly, together with the metal part and with the first end face leading, is pushed through the terminal opening of the housing cup into the housing cup so far that the projection is inserted into the aperture or protrudes through the aperture,

e. a cavity between the metal part and the bottom is filled with a casting compound that has electrically insulating properties when hardened.

When the potting compound has hardened, it forms the seal in the annular gap described above for the energy storage element.

Preferably, the method of manufacturing the energy storage element is characterized by at least one of the features a. and b. immediately below:

a. Before step c. of the method described above, at least one spacer made of an electrically insulating material is arranged on the bottom of the housing cup or on the metal part in order to define the dimensions of the cavity between the metal part and the bottom.

b. The spacer is a disk or annular.

Preferably, the immediately preceding features a. and b. are realized in combination.

Preferably, the method of manufacturing the energy storage element is additionally or alternatively characterized by at least one of the features a. to d. immediately below:

a. An electrode-separator assembly is inserted into the housing cup, in which the ribbon-shaped electrodes are formed and/or arranged such that the free edge strip of the anode current collector or the cathode current collector protrudes from the first terminal end face and the other of the free edge strips protrudes from the second terminal end face of the electrode-separator assembly.

b. The energy storage element comprises the metal part covering the first terminal end face as the first metal part.

c. Before or after the electrode-separator assembly is inserted into the housing cup, a second metal part is arranged on the second terminal end face and connected there by welding to the free edge strip protruding from the second terminal end face.

d. The edge of the second metal part is welded all around to the housing cup.

It is preferred that the immediately preceding features a. to c. or a. to d. are realized in combination.

Preferably, the method of manufacturing the energy storage element is additionally or alternatively characterized by at least one of the features a. to c. immediately below:

a. An electrolyte is filled into the interior space of the housing cup through an opening in the first or second metal part.

b. The opening in the metal part is closed, in particular by means of a membrane designed to burst in the event of a predetermined overpressure prevailing inside the housing.

c. The opening has a circular shape.

It is preferred that the immediately preceding features a. and b., a. and c. or a. to c. are realized in combination.

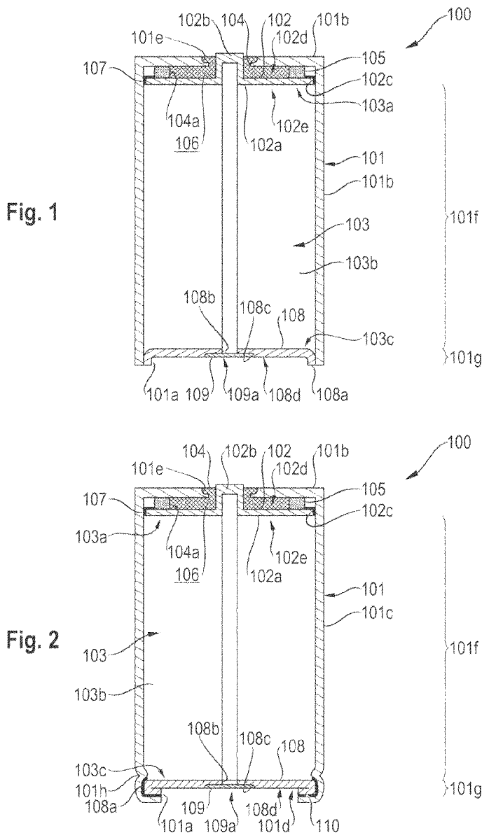

FIG. 1 and FIG. 2 show a first and a second embodiment of an energy storage element 100, each of which has an airtight and liquid-tight sealed housing comprising a metallic housing cup 101 with a terminal circular opening 101a, a bottom 101b, a circumferential side wall 101c and a lid 101d. The bottom 101b of the housing cup 101 has an aperture 101e, which is produced, for example, by means of a punching process through the bottom 101b of the housing cup 101.

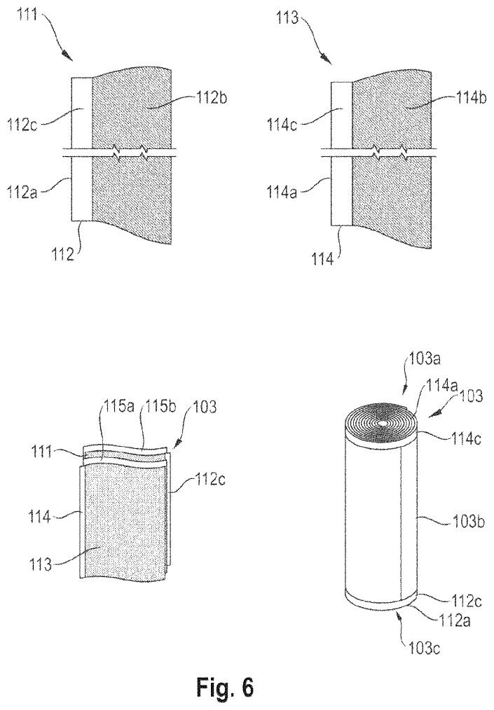

The energy storage element 100 comprises a metal part 102 which covers a first terminal end face 103a of an electrode-separator assembly 103 (the electrode-separator assembly will be described with reference to FIG. 6) and is formed as a first metal part 102 in the present case. The first metal part 102 comprises a flat region 102a, to which a free edge strip of the electrode-separator assembly 103 protruding from the first terminal end face 103a is welded, and a cup-shaped projection 102b pointing away from the first terminal end face 103a. The metal part 102 is a one-part piece including the cup-shaped projection 102b and is produced by a forming, for example deep drawing, or machining production step, for example milling, or alternatively by 3D printing.

The cup-shaped projection 102b protrudes through the aperture 101e of the housing cup base 101b, so that the cup-shaped projection 102b can be contacted mechanically from outside the housing by an external energy consumer-indirectly via a conductor or directly. The first metal part 102 is a disk, has a circular edge 102c, a first side 102d directed towards the bottom 101b of the housing cup 101 and a second side 102e directed towards the electrode-separator assembly 103. The projection 102b shaped as a cup has a cylindrical shape and appears on the second side 102e of the metal part 102 as a cylindrical depression and on the first side 102d of the metal part 102 as a cylindrical elevation.

The bottom 101b and the first metal part 102 are insulated from each other by an electrically insulating seal 104, which in the present case is formed as a first seal 104 and is realized by a hardened casting compound, wherein the seal 104 is formed as a disc at least in some areas and has a circular edge 104a.

In addition, an annular spacer 105 made of an electrically insulating material is arranged between the bottom 101b of the housing cup 101 and the first metal part 102, which together with the first side 102d of the first metal part 102 and the bottom 101b of the housing cup 101 forms an annular gap 106. The annular gap 106 is filled by the seal 104 made of the hardened casting compound.

The energy storage element 100 further comprises an insulating means 107 made of an electrically insulating material, which is arranged between the circular edge 102c of the first metal part 102 and the housing cup 101 and electrically insulates the circular edge 102c of the first metal part 102 from the potential of the housing cup 101. In the present example, the insulating means 107 comprises a polyimide at least as a partial component. Specifically, the insulating agent is in the form of Kapton® adhesive tape from the company DuPont.

In preferred embodiments, instead of an insulating means 107, which is separate from the spacer 105, an annular plastic component can also be placed on the edge of the metal part 102 (see FIG. 4), which fulfills both the function of the spacer 105 and that of the insulating means 107, i.e. simultaneously serves to form the aforementioned annular gap and electrically insulates the circular edge 102c of the first metal part 102 from the potential of the housing cup 101. This reduces complexity and simplifies manufacture.

The housing cup 101 comprises, in axial sequence, the bottom 101b, a cylindrically formed central section 101f and a lid closure section 101g. In the central section 101f, a winding shell 103b of the electrode-separator assembly 103, which is formed as a winding, is in contact with an inner side of the housing cup 101.

Ribbon-shaped electrodes, as shown in FIG. 6, are formed as and arranged within the electrode-separator assembly 103, which is formed as a winding, in such a way that an edge strip of a current collector protrudes from the first terminal end face 103a and an edge strip of another current collector protrudes from the second terminal end face 103c of the electrode-separator assembly 103. In the present case, a first free edge strip of the cathode current collector protrudes from the first terminal end face 103a of the electrode-separator assembly 103 and a free edge strip of the anode current collector protrudes from the second terminal end face 103c of the electrode-separator assembly 103.

The free edge strip of the cathode current collector protruding from the first terminal end face 103a extends along a first longitudinal edge, which is only provided with a reference number with respect to FIG. 6, and forms an area on which the first metal part 102 rests. The first metal part 102 is welded to the area formed by the free edge strip of the cathode current collector and essentially covers the entire first terminal end face 103a (see FIG. 4).

In addition to the first metal part 102, the energy storage element 100 comprises a second metal part 108, which covers the second terminal end face 103c of the electrode-separator assembly and is welded directly to the free edge strip of the electrode-separator assembly 103 protruding from the second terminal end face 103c (see FIG. 4). In the embodiments of FIG. 1 and FIG. 2, the second metal part 108 forms the lid 101d of the housing and closes the terminal circular opening 101a of the housing cup 101. Like the first metal part 102, the second metal part 108 is dimensioned such that it covers substantially the entire second terminal end face 103c of the electrode-separator assembly 103. The second metal part 108 is also formed as a disk and has a circular edge 108a.

Further, the second metal member 108 has a circular opening 108b and a recessed area 108c surrounding the circular opening 108b in which the thickness is reduced compared to the rest of the second metal member 108. The circular opening 108b of the second metal part 108 is closed by a membrane 109, which is designed to burst in the event of a predetermined overpressure prevailing inside the housing. The membrane 109 therefore acts as a safeguard against internal overpressure in the lid closure section 101f of the housing cup 101. The membrane 109 is recessed in the recess region 108c of the second metal part 108 and is configured such that a surface 109a of the membrane 109 facing away from the electrode-separator assembly 103 lies in a common plane with a surface 108d of the second metal part 108 facing away from the electrode-separator assembly 103.

The first metal portion 102 and the second metal portion 108 have a substantially uniform thickness in a range from 150 μm to 350 μm.

In the first embodiment of the energy storage element 100 according to FIG. 1, the circular edge 108a of the second metal part 108 is bent through 90° and welded all around to the housing cup 101.

In the second embodiment of the energy storage element 100 according to FIG. 2, on the other hand, the central section 101f and the lid closure section 101g of the housing cup 101 are separated from each other by a radial bead 101h, which circumferentially surrounds the outside of the housing cup 101 in an annular manner. A second seal 110, which is arranged in the lid closure section 101g, is in press contact with the second metal part 108 and the inside of the housing cup 101 and electrically insulates the two parts from each other. The second seal 110 preferably has a circular edge 110a.

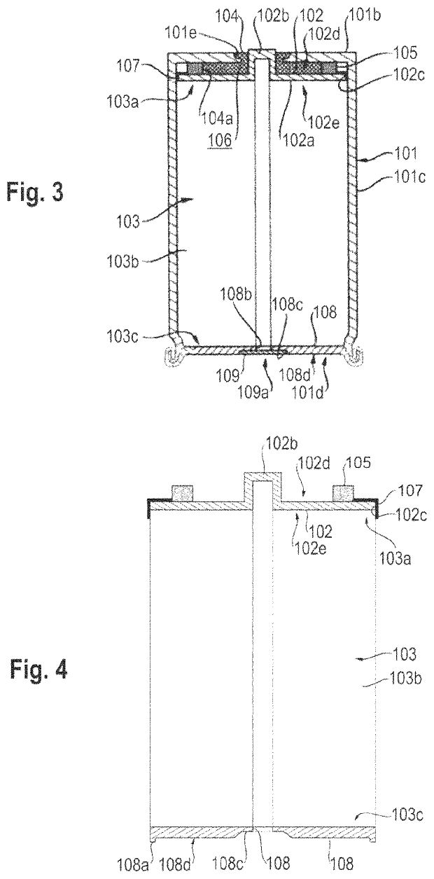

The third embodiment of the energy storage element 100 shown in FIG. 3 differs from the first and second embodiments only in that the second metal part 108 is connected to the housing cup 101 by a folded closure. In this embodiment, the housing is of course not potential-free, it will have anode or cathode potential depending on the design.

A preferred structure of the electrode-separator assembly is shown in FIG. 6. The electrode-separator assembly 103 comprises a ribbon-shaped anode 111 with a ribbon-shaped anode current collector 112 and a ribbon-shaped cathode 113 with a ribbon-shaped cathode current collector 114. The anode current collector 112 is preferably a foil made of copper or nickel. The cathode current collector 114 is preferably an aluminum foil. Both the anode current collector 112 and the cathode current collector 114 have a first longitudinal edge 112a, 114a and a second longitudinal edge, a main region 112b, 114b and a free edge strip 112c, 114c. The main regions 112b, 114b are loaded with a layer of electrode material, in the case of the anode 111 with negative electrode material, in the case of the cathode 113 with positive electrode material. The free edge strips 112c, 114c extend along the respective first longitudinal edge 112a, 114a and are not loaded with electrode material. Both electrodes are shown individually in an unwound state. Within the wound electrode-separator assembly 103, the anode 111 and the cathode 113 are offset from each other such that the first longitudinal edge 114a of the cathode current collector 114 protrudes from the first terminal end face 103a of the electrode-separator assembly 103. The first longitudinal edge 112a of the anode current collector 112 protrudes from the second terminal end face 103c of the electrode-separator assembly. This can be clearly seen in the illustration at the bottom right. The staggered arrangement can be seen in the illustration on the bottom left. Two ribbon-shaped separators 115a and 115b are also shown there, which separate the electrodes 111, 113 from each other in the winding. The winding shell 103b of the electrode-separator assembly 103 is usually formed by a plastic film.

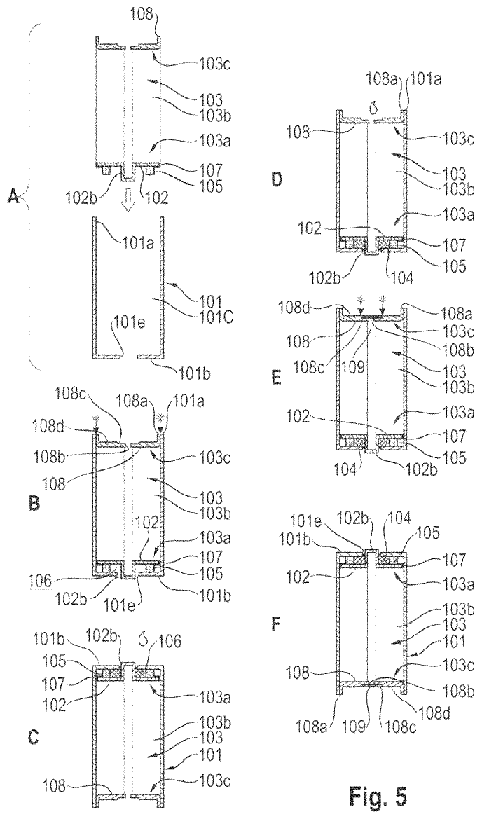

With reference to FIG. 5, the method of manufacturing an energy storage element 100 as described above will now be explained below.

In a first step shown under A, the housing cup 101 with the terminal circular opening 101a and an aperture 101e in the bottom 101b and an electrode-separator assembly 103 with a first terminal end face 103a and a second terminal end face 103c, as described above, are provided. In addition, the first metal part 102 with the projection shaped as a cup 102a is provided. Still in step A, the first metal part 102 is arranged on the first end face 103a and is connected by welding to the free edge strip 112c or 114c protruding from the first end face 103a. Furthermore, in the present embodiment of the method, the second metal part 108 is provided and connected by welding to the other of the free edge strips 112c or 114c protruding from the second end face 103c.

In a second step shown under B, the electrode-separator assembly 103 together with the first metal part 102 and preferably with the second metal part 108 and with the first end face 103a leading is pushed through the terminal circular opening 101a of the housing cup 101 into the housing cup 101 so far that the projection 102a shaped as a cup protrudes through the aperture 101e of the housing cup base 101b. The annular spacer 105 made of the electrically insulating material is arranged on the housing cup base 101b or on the metal part 102 in order to define the dimensions of a cavity, in this case the annular gap 106 described above, between the metal part 102 and the bottom 101b. When an energy storage element 100 is manufactured according to the embodiment of FIG. 1, the circular edge 108a of the second metal part is preferably welded all around to the housing cup 101 by means of a laser or the like.

In a second step shown in C and D, the annular gap 106 between the first metal part 102 and the bottom 101b is filled with a potting compound which has electrically insulating properties in the cured state and forms the first seal 104. The potting compound is then cured, for example in air and at room temperature, but preferably at 100° C. under vacuum.

In a third step shown under E, an electrolyte is filled into the interior space of the housing cup 101 through the circular opening 108b in the second metal part 108. Preferably, the energy storage element 100 is still under vacuum at this time. Thus, undesired penetration of suspended matter into the interior of the housing can be avoided.

In a final step shown in F, the circular opening 108b in the second metal part 108 is closed, preferably by means of the membrane 109, which is designed to burst in the event of a predetermined overpressure prevailing inside the housing. For this purpose, the membrane 109 is welded to the second metal part 108 in the recess region 108c of the second metal part 108 by means of a laser or the like.

Alternatively, the opening 108b can also be closed by means of a rivet. In this case, the rivet comprises a first flange inside the housing, a second flange outside the housing and a shank passing through the opening and connecting the first and second flanges. The first and second flanges enclose the housing part 108 between them. A recess area 108c is not required in this case. In preferred embodiments, an annular seal, for example made of a suitable polymer material, may be disposed between the first flange and the housing part 108 and/or between the second flange and the housing part 108. Alternatively, the first flange and the housing part 108 and/or the second flange and the housing part 108 may also be assembled by a weld seam. This may, for example, be a circular weld seam around the opening 108b.

It is understood that the above explanations of the specific embodiments shown in FIG. 1 to FIG. 5 are merely preferred embodiments and do not limit the scope of the present invention.

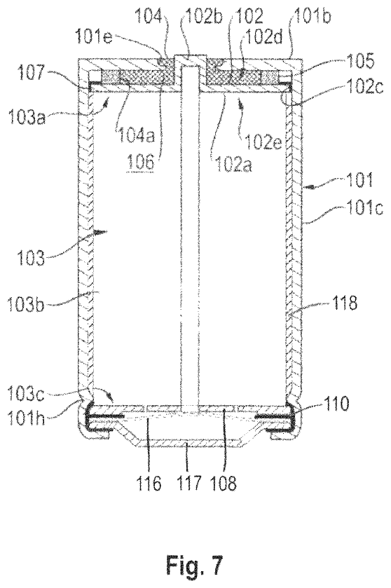

The fourth embodiment of the energy storage element 100 shown in FIG. 7 differs from the first and second embodiments in that the second metal part 108 is part of a multi-part lid assembly which, in addition to the metal part 108, comprises a metallic membrane 116 and a pole cap 117 and an electrically insulating seal 110. The seal 110 insulates the membrane 116 in edge regions from the metal part 108, whereas the center of the membrane is preferably connected to the metal part 108 by welding. In the event of an irregular overpressure in the cell, the membrane 116 can bulge outwards so that the connection to the metal part 108 breaks off.

Furthermore, the energy storage element 100 has a thin lithium layer 118 on the inside of the housing shell. This layer serves as a lithium depot and is able to compensate for losses of lithium ions during operation. Furthermore, the layer can also serve as a reference electrode, as the layer is in direct contact with the housing and thus in electrical contact with it. For example, a voltage gradient between the reference electrode and the positive or negative electrode can be determined. By applying a corresponding voltage, the concentration of lithium ions in the electrolyte of the energy storage element can also be specifically influenced.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage element, comprising
an electrode-separator assembly in the form of a cylindrical winding with a first terminal end face, a second terminal end face. and a winding shell therebetween, the electrode-separator assembly comprising an anode, a separator, and a cathode in a sequence anode/separator/cathode wherein:
the anode comprises a ribbon-shaped anode current collector comprising a first longitudinal edge, a second longitudinal edge parallel thereto, a main region loaded with a layer of a negative electrode material, and a free edge strip extending along the first longitudinal edge and being not loaded with the negative electrode material,
the cathode comprises a ribbon-shaped cathode current collector comprising a first longitudinal edge, a second longitudinal edge parallel thereto, a main region loaded with a layer of a positive electrode material, and a free edge strip extending along the first longitudinal edge and being not loaded with the positive electrode material,
the anode and the cathode are formed and/or arranged within the electrode-separator assembly, which is formed as a winding, such that the free edge strip of the cathode current collector or the free edge strip of the anode current collector protrudes from the first terminal end face,
housing closed in an airtight and liquid-tight manner, the housing comprising a metallic housing cup and a lid, the metallic housing cup comprising a bottom, a circumferential side wall, and a terminal opening;
a one-piece metal part covering the first terminal end face and comprising a flat region and a projection pointing away from the first terminal end face; and
an electrically insulating seal that insulates the bottom of the metallic housing cup and the one-piece metal part,
wherein the anode and the cathode are formed and/or arranged within the electrode-separator assembly such that a respective free edge strip protrudes from the first terminal end face, the respective free edge strip being the free edge strip of the anode current collector or the free edge strip of the cathode current collector,
wherein the respective free edge strip is welded to the flat region of the metal part,
wherein a respective first longitudinal edge corresponding to the respective free edge strip forms an area on which the metal part covering the first end face lies flat at least in a subareas or into which the metal part is pressed at least in a subarea,
wherein the bottom of the housing cup comprises an aperture into which the projection is inserted or through which the projection protrudes, such that the projection is configured to be mechanically contacted from outside the housing.

2. The energy storage element according to claim 1, wherein
the projection of the one-piece metal part is shaped as a cup

3. The energy storage element according to claim 1 wherein at least one of
the ribbon-shaped electrodes are formed and/or arranged within the electrode-separator assembly such that a second respective free edge strip collector or of protrudes from the second terminal end face of the electrode-separator assembly, the second respective free edge strip being the free edge strip of the cathode current collector or the free edge strip of the anode current collector.
a second metal part covers the second terminal end face and is welded directly to the second respective free edge strip,
d. the second metal part forms the lid of the housing, and/or
the second metal part closes the terminal opening of the housing cup.

4. The energy storage element according to claim 2, wherein at least one of:
the terminal opening of the housing cup has a circular shape,
the first and/or the second metal part is formed as a disk and has a circular edge,
the circular edge of the second metal part is bent by 90°,
the seal is formed as a disk or an annulus at least in some areas and has an annular edge, and/or
the energy storage element comprises an insulator made of an electrically insulating material, and arranged between the edge of the metal part covering the first end face and the housing cup and electrically insulates the edge of the first metal part from the potential of the housing cup.

5. The energy storage element according to claim 1, wherein at least one of:
the housing comprises the bottom a central section and a lid closure section in an axial sequence,
the central section the winding shell of the electrode-separator assembly, is in contact with an inside of the housing cup, and/or
the central section has a cylindrical shape.

6. The energy storage element according to claim 1, wherein at least one of
the metal part has a first side directed towards the bottom of the housing cup and a second side directed towards the electrode-separator assembly,
an annular spacer made of an electrically insulating material is arranged between the bottom of the housing cup and the metal part, and/or
the spacer, the first side of the metal part and the bottom of the housing cup form an annular gap which is filled by the electrically insulating seal.

7. The energy storage element according to any claim 1, wherein at least one of features:
the respective first longitudinal edge forms an area on which the metal part covering the first end face lies flat, at least in a subarea, or into which the metal part is pressed, at least in a subarea,
the metal part is dimensioned such that it covers at least 40 %, of the first terminal end face,
the metal part covering the first end face has a uniform thickness in a range of 50 μm to 600 μm, and/or
the projection of the metal part has a cylindrical shape and appears as a cylindrical depression on a second side of the metal part and as a cylindrical elevation on a first side of the metal part.

8. The energy storage element according to 3, wherein at least one of:
the second respective longitudinal edge, forms an area against which the second metal part lies flat, at least in a subarea, or into which the second metal part is pressed, at least in a subarea,
the second metal part is dimensioned such that it covers at least 40%, of the second terminal end face, and/or
the second metal part has a preferably uniform thickness in a range from 50 μm to 600 μm,

9. The energy storage element according to claim 5, wherein at least one of
the central section and the lid closure section are separated from each other by a radial bead, which circumferentially surrounds the outside of the housing cup in an annular manner,
a second seal is arranged in the lid closure section, which is in press contact with the second metal part and the inside of the housing cup, and/or
a second seal has an annular shape and has a circular edge.

10. The energy storage element according to claim 1, wherein at least one of:
the energy storage element comprises a protection against internal overpressure in the lid closure section,
the second metal part comprises an opening and a recessed area surrounding the opening, in which the thickness is reduced compared to the rest of the second metal part,
the opening of the second metal part has a circular shape,
opening of the second metal part is closed by a membrane configured to burst in an event of a predetermined overpressure prevailing inside the housing,
the membrane is recessed in the recess area of the second metal part, and/or
a surface of the membrane facing away from the electrode-separator assembly extends in a common plane with a surface of the second metal part facing away from the electrode-separator assembly.

11. A method of manufacturing the energy storage element according to claim 1, the method comprising:
providing the housing cup and an the electrode-separator assembly;
providing the metal part comprising the projection;
arranging the metal part on the first end face and welding the metal part to the first respective free edge strip;
the pushing the electrode-separator assembly together with the metal part and with the first end face leading, through the terminal opening of the housing cup into the housing cup so far that the projection is inserted into the aperture or protrudes through the aperture; and
filling a cavity between the metal part and the bottom with a casting compound that has electrically insulating properties when hardened.

12. The method of claim 11, further comprising,
before arranging the metal part on the first end face and welding the metal part to the first respective free edge strip, arranging at least one spacer made of an electrically insulating material on the bottom of the housing cup or on the metal part to define the dimensions of the cavity between the metal part and the bottom,
wherein the spacer is a disk or annular.

13. The method according to claim 11, wherein at least one of:
the electrode-separator assembly is inserted into the housing cup such that the first respective free edge strip protrudes from the first terminal end face and the other of the free edge strip of the anode current collector or the free edge strip of the cathode current collectors protrudes from the second terminal end face of the electrode-separator assembly.
the energy storage element comprises the metal part covering the first terminal end face as the first metal part,
before or after the electrode-separator assembly is inserted into the housing cup, a second metal part is arranged on the second terminal end face and connected there by welding to the free edge strip protruding from the second terminal end face and/or
the edge of the second metal part is welded all around to the housing cup.

14. The method according to claim 11, wherein at least one of
an electrolyte is filled into the interior space of the housing cup through an opening in the second metal part
the opening in the second metal part is closed, by a membrane designed to burst in the event of a predetermined overpressure prevailing inside the housing, and/or
the opening has a circular shape.
